(19) United States
(12) Patent Application Publication
(10) Pub. No.: US 2025/0118851 A1
(43) Pub. Date: Apr. 10, 2025

(54) TUNABLE SPRING THAT ACCOMODATES CELL-TO-CELL EXPANSION IN A BATTERY ASSEMBLY

(71) Applicant: GM Global Technology Operations LLC, Detroit, MI (US)

(72) Inventors: Daniel Philip Pothen, Ann Arbor, MI (US); Paul Buchholz, Warren, MI (US); Tejas R. Bhavsar, Troy, MI (US); Rajesh K. Bhagirath, Lasalle (CA)

(21) Appl. No.: 18/483,201

(22) Filed: Oct. 9, 2023

(51) Int. Cl. H01M 50/291; B60L 50/64; H01M 50/209; H01M 50/242; H01M 50/249

(52) U.S. Cl. CPC H01M 50/291; B60L 50/64; H01M 50/209; H01M 50/242; H01M 50/249; H01M 2220/20

(57) ABSTRACT

A battery assembly includes a first battery cell including a first surface and a first surface section. The first surface is opposite the second surface. A second battery cell includes a second surface and a second surface section. The second surface section is opposite of the second surface. A tunable spring member is provided between the first battery cell and the second battery cell. The tunable spring member includes a first spring surface facing the first surface section and a second spring surface facing the second surface. The tunable spring member includes a plurality of energy absorption zones disposed across the first spring surface and the second spring surface. A first portion of the plurality of energy absorption zones establish a first spring rate, and a second portion of the plurality of energy absorption zones establish a second spring rate that is distinct from the first spring rate.

### INTRODUCTION

The subject disclosure relates to the art of battery assemblies and, more particularly, to a tunable spring that accommodates cell-to-cell expansion in a battery assembly.

Prior art battery assemblies are formed from a plurality of battery cells such as shown at 2 in FIG. 1. Battery cells 2 are typically separated by foam inserts 3 that may accommodate battery cell expansion. Charging and discharging of the battery cells 2 will, over time, lead to cell wall expansions. The foam inserts 3 are placed between adjacent battery cells 2 in order to create space and accommodate the expansions. When being inserted, the foam often folds or wrinkles making assembly more difficult. Foam inserts include a constant spring force and current materials are not capable of supporting battery expansion forces. As such, many expansions of prior art battery cells lead to bulging side walls 4 having a non-uniform shape as shown in FIG. 1. Bulging side walls 4 may exert undesirable, uneven, pressure on adjacent battery cells 2 that may detract from battery performance. Accordingly, it is desirable to provide a system for controlling battery-to-battery cell expansion.

### SUMMARY

A battery assembly, in accordance with a non-limiting example, includes a first battery cell including a first surface and a first surface section. The first surface section is opposite of the first surface. A second battery cell includes a second surface and a second surface section. The second surface section is opposite of the second surface. A tunable spring member is provided between the first battery cell and the second battery cell. The tunable spring member includes a first spring surface facing the first surface section and a second spring surface facing the second surface. The tunable spring member includes a plurality of energy absorption zones disposed across the first spring surface and the second spring surface. A first portion of the plurality of energy absorption zones establish a first spring rate, and a second portion of the plurality of energy absorption zones establish a second spring rate that is distinct from the first spring rate.

In addition to one or more of the features described herein the tunable spring member includes a first side, a second side arranged opposite the first side, a first edge extending between and connecting the first side and the second side, and a second edge, opposite the first edge, extending between and connecting the first side and the second side, the first side, the second side, the first edge, and the second edge defining a deflection area.

In addition to one or more of the features described herein the first edge and the first side form a first corner, the first edge and the second side form a second corner, the second edge and the first side form a third corner, and the second edge and the second side form a fourth corner, the first portion of the plurality of energy absorption zones being disposed at one of the first corner, the second corner, the third corner, and the fourth corner.

In addition to one or more of the features described herein the first corner, the second corner, the third corner, and the fourth corner includes one of the first portion of the plurality of energy absorption zones.

In addition to one or more of the features described herein the deflection area includes a central deflection zone defined between the first edge, the second edge, the first side, and the second side, wherein the central deflection area includes a plurality of the second portion of the plurality of energy absorption zones.

In addition to one or more of the features described herein the deflection area includes a first edge region defined between the first corner and the second corner and a second edge region defined between the third corner and the fourth corner, wherein the first edge region and the second edge region includes a third portion of the plurality of energy absorption zones establishing a third spring rate.

In addition to one or more of the features described herein the deflection area includes a first side region defined between the first corner and the third corner and a second side region defined between the second corner and the fourth corner, wherein the first side region and the second side region includes a fourth portion of the plurality of energy absorption zones establishing a fourth spring rate.

In addition to one or more of the features described herein the third spring rate is distinct from the fourth spring rate.

In addition to one or more of the features described herein the third spring rate and the fourth spring rate are distinct from the first spring rate and the second spring rate.

In addition to one or more of the features described herein each of the first portion of the plurality of energy absorption zones is defined by an opening having a first dimension formed in the deflection area and each of the second portion of the plurality of energy absorption zones is defined by a second opening having a second dimension formed in the deflection area, the first dimension being distinct from the second dimension.

A vehicle, in accordance with a non-limiting example, includes a body including a passenger compartment, a drive unit supported in the body, and a battery assembly operatively connected to the drive unit. The battery assembly includes a first battery cell including a first surface and a first surface section, the first surface section is opposite of the first surface. A second battery cell including a second surface and a second surface section. The second surface section is opposite of the second surface. A tunable spring member is provided between the first battery cell and the second battery cell. The tunable spring member includes a first spring surface facing the first surface section and a second spring surface facing the second surface. The tunable spring member includes a plurality of energy absorption zones disposed across the first spring surface and the second spring surface, a first portion of the plurality of energy absorption zones establishing a first spring rate, and a second portion of the plurality of energy absorption zones establishing a second spring rate that is distinct from the first spring rate.

In addition to one or more of the features described herein the tunable spring member includes a first side, a second side arranged opposite the first side, a first edge extending between and connecting the first side and the second side, and a second edge, opposite the first edge, extending between and connecting the first side and the second side, the first side, the second side, the first edge, and the second edge defining a deflection area.

In addition to one or more of the features described herein the first edge and the first side form a first corner, the first edge and the second side form a second corner, the second edge and the first side form a third corner, and the second edge and the second side form a fourth corner, the first portion of the plurality of energy absorption zones being disposed at one of the first corner, the second corner, the third corner, and the fourth corner.

In addition to one or more of the features described herein the first corner, the second corner, the third corner, and the fourth corner includes one of the first portion of the plurality of energy absorption zones.

In addition to one or more of the features described herein the deflection area includes a central deflection zone defined between the first edge, the second edge, the first side, and the second side, wherein the central deflection area includes a plurality of the second portion of the plurality of energy absorption zones.

In addition to one or more of the features described herein the deflection area includes a first edge region defined between the first corner and the second corner and a second edge region defined between the third corner and the fourth corner, wherein the first edge region and the second edge region includes a third portion of the plurality of energy absorption zones establishing a third spring rate.

In addition to one or more of the features described herein the deflection area includes a first side region defined between the first corner and the third corner and a second side region defined between the second corner and the fourth corner, wherein the first side region and the second side region includes a fourth portion of the plurality of energy absorption zones establishing a fourth spring rate.

In addition to one or more of the features described herein the third spring rate is distinct from the fourth spring rate.

In addition to one or more of the features described herein the third spring rate and the fourth spring rate are distinct from the first spring rate and the second spring rate.

In addition to one or more of the features described herein each of the first portion of the plurality of energy absorption zones is defined by an opening having a first dimension formed in the deflection area and each of the second portion of the plurality of energy absorption zones is defined by a second opening having a second dimension formed in the deflection area, the first dimension being distinct from the second dimension.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an elevational view of adjacent battery cells separated by foam insets, in accordance with the prior art;

FIG. 2 is a left side view of a vehicle including a battery assembly having a tunable spring, in accordance with a non-limiting example;

FIG. 3 is a disassembled view of the battery assembly of FIG. 2, in accordance with a non-limiting example;

FIG. 4 is a view of battery cells separated by tunable spring members, in accordance with a non-limiting example;

FIG. 5 is a perspective view of the tunable spring mounted to a battery cell, in accordance with a non-limiting example;

FIG. 6 is a perspective view of the tunable spring member of FIG. 5, in accordance with a non-limiting example;

FIG. 7 is an elevational view of adjacent battery cells separated by the tunable spring member of FIG. 6, in accordance with a non-limiting example; and

FIG. 8 is an elevational view of the adjacent battery cells of FIG. 7 showing the tunable spring member controlling battery cell expansion, in accordance with a non-limiting example.

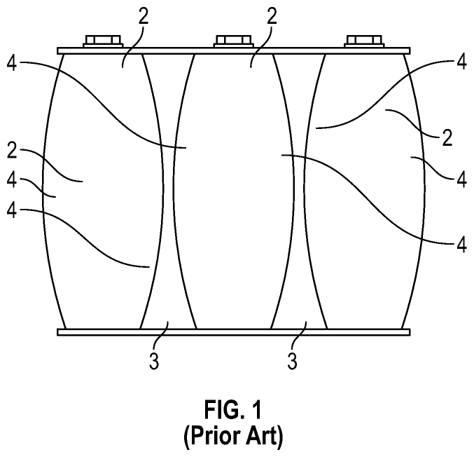

### DETAILED DESCRIPTION

The following description is merely exemplary in nature and is not intended to limit the present disclosure, its application or uses. It should be understood that throughout the drawings, corresponding reference numerals indicate like or corresponding parts and features.

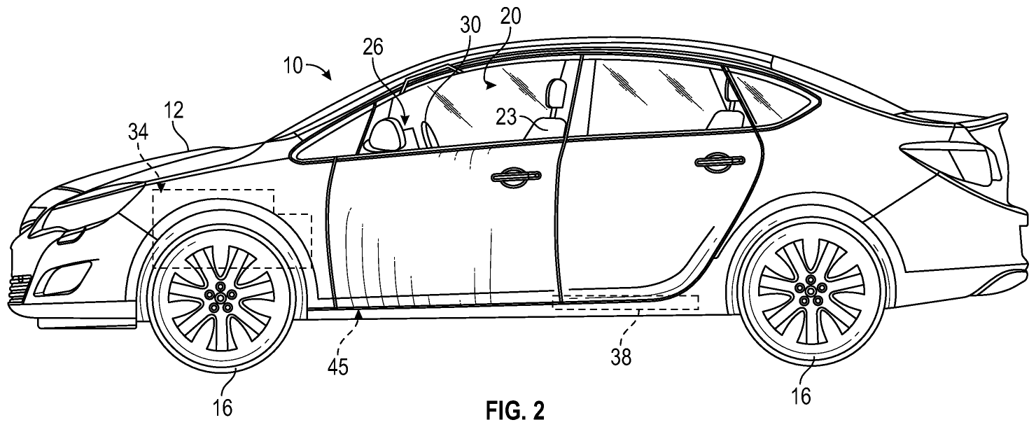

A vehicle, in accordance with a non-limiting example, is indicated generally at 10 in FIG. 2. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. Vehicle 10 includes an electric drive unit 34 that provides power to one or more of the plurality of wheels 16.

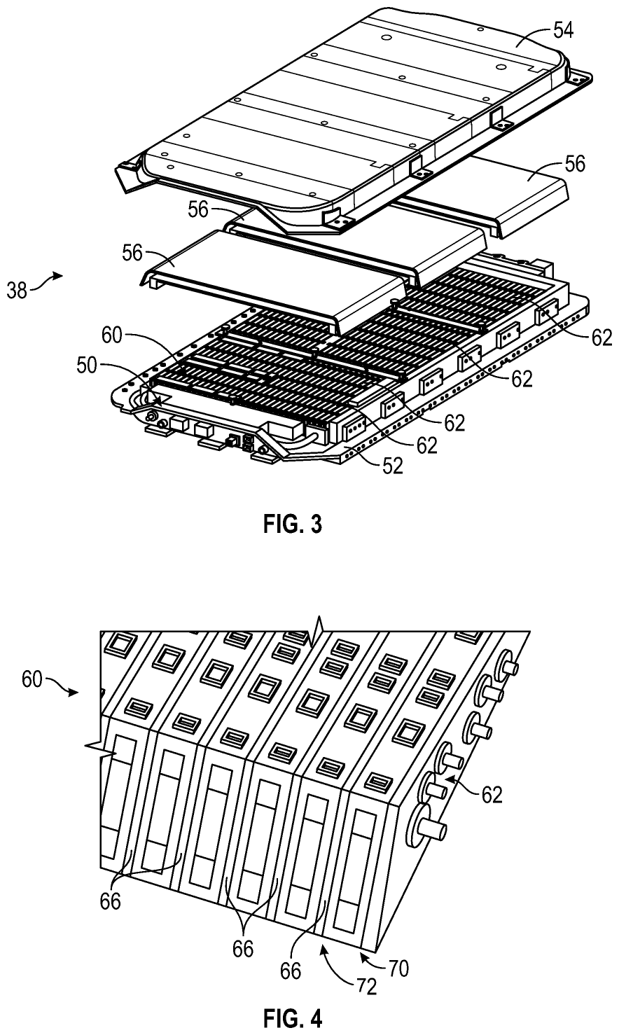

A rechargeable energy storage system (RESS) or battery assembly 38 is arranged in body 12 and provides power to electric drive unit 34. In other arrangements, a fuel cell (not shown) may be used to provide power to electric drive unit 34. At this point, it should be understood that the location of electric drive unit 34 and battery assembly 38 may vary. As shown in FIG. 3, RESS 38 includes a housing 50 having a base 52, an outer cover 54, and a number of inner covers 56. Inner covers 56 shied a plurality of battery cells 60 arranged in a number of adjacent rows 62. Battery cells 60 are separated by a tunable spring members 66 which, as will be detailed herein, absorb expansion forces between adjacent cells.

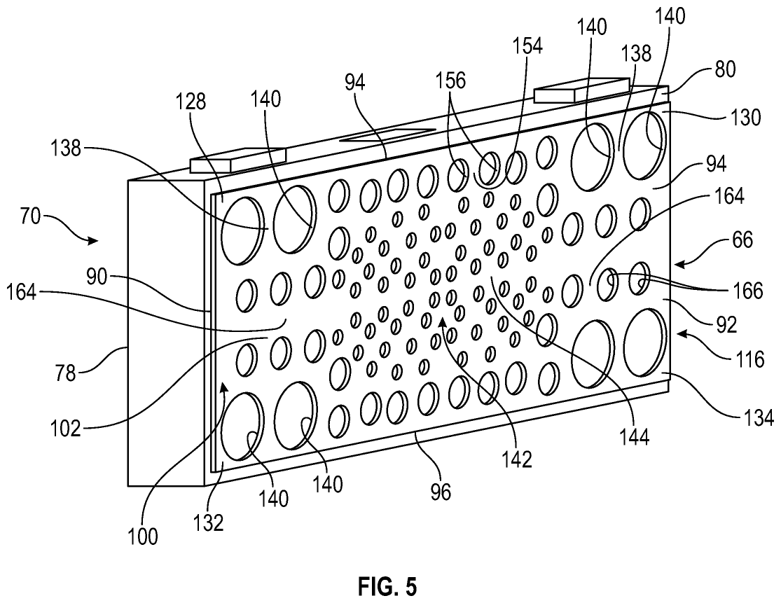

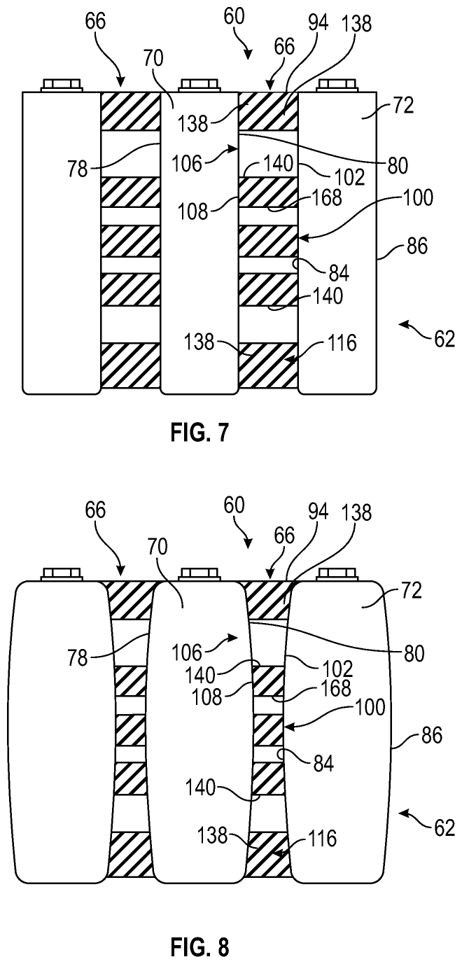

As shown in FIG. 4, each of the adjacent rows 62 of the plurality of battery cells 60 include a first battery cell 70 arranged adjacent to a second battery cell 72. The number of battery cells 60 in each of the adjacent rows 62 may vary. As shown in FIG. 5, first battery cell 70 includes a first surface 78 and a first surface section 80 arranged opposite of and substantially parallel to first surface 78. Second battery cell 72, as shown in FIG. 7, includes a second surface 84 and a second surface section 86. Second surface section 86 is opposite of, and substantially parallel to, second surface 84.

Tunable spring member 66 is arranged between first surface section 80 and second surface 84. Of course, it should be understood that additional tunable spring members 66 are arranged between others of the plurality of cells 60. Tunable spring member 66 controls expansion of first battery cell 70 and second battery cell 72. That is, as will be detailed herein, tunable spring member 66 is selectively tuned to force a more uniform expansion of first surface section 80 and second surface 84 to enhance an overall operational efficiency of first battery cell 70 and second battery cell 72.

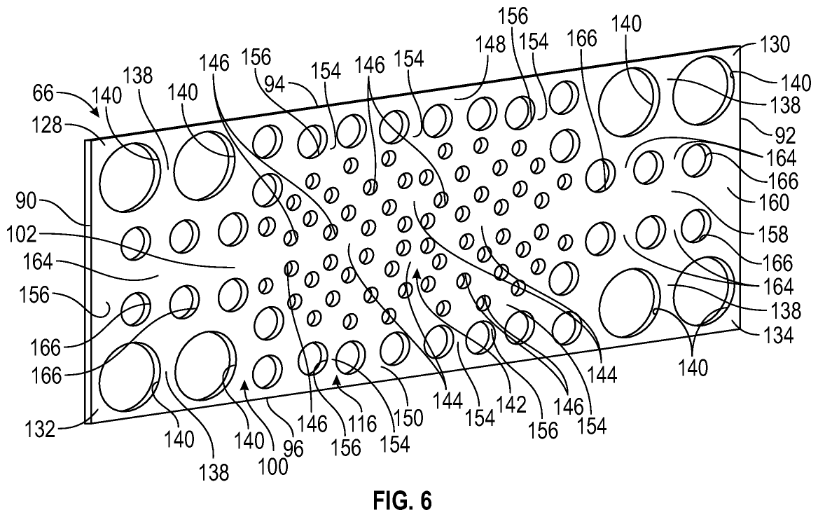

Referring to FIGS. 6 and 7 and with continued reference to FIG. 5, tunable spring member 66 includes a first side 90 and a second side 92 that is opposite first side 90. Tunable spring member 66 includes a first edge 94 and a second edge 96 that extend between and connect with first side 90 and second side 92. First side 90, second side 92, first edge 94, and second edge 96 define a first spring surface 100 having a first deflection area 102, and a second spring surface 106 having a second deflection area 108. First deflection area 102 and second deflection area 108, as will be detailed herein, absorb and guide expansion forces of first surface section 80 and second surface 84. Tunable spring member 66 includes a plurality of energy absorption zones 116 arrayed across first deflection area 102 and second deflection area 108.

In accordance with a non-limiting example, tunable spring member 66 includes a first corner 128 defined at an intersection of first side 90 and first edge 94, a second corner 130 defined at an intersection of second side 92 and first edge 94, a third corner 132 defined at an intersection of first side 90 92 and second edge 96, and a fourth corner 134 defined at an intersection of second side 92 and second edge 96. A first portion 138 of the plurality of energy absorption zones 116 are arranged at each of the first corner 128, the second corner 130 the third corner 132, and the fourth corner 134. The first portion 138 of the plurality of energy absorption members 116 a formed by first openings or voids 140 in tunable spring member 66 that create a first spring rate in each of the first deflection area 102 and the second deflection area 108.

In a non-limiting example, tunable spring member 66 also includes a central deflection zone 142 generally centrally spaced from each of the first side 90, the second side 92, the first edge 94, and the second edge 96. Central deflection zone 142 includes a second portion 144 of the plurality of energy absorption members 116. The second portion 144 of the plurality of energy absorption members 116 is formed by second openings or voids 146 in tunable spring member 66 that create a second spring rate in each of the first deflection area 102 and the second deflection area 108. The second spring rate is distinct from the first spring rate. In a non-limiting example, the second spring rate is greater than the first spring rate.

In a non-limiting example, tunable spring member 66 further includes a first edge region 148 extending along first edge 94 between first corner 128 and second corner 130, and a second edge region 150 extending along second edge 96 between third corner 132 and fourth corner 134. A third portion 154 of the plurality of energy absorption members 116 is disposed in each of the first edge region 148 and the second edge region 150. The third portion 154 of the plurality of energy of absorption members 116 is formed by third openings or voids 156 in tunable spring member 66 that create a third spring rate in each of the first deflection area 102 and the second deflection area 108. The third spring rate may be less than the second spring rate yet greater than the first spring rate.

In a non-limiting example, tunable spring member 66 still further includes a first side region 156 extending along first side 90 between first corner 128 and third corner 132, and a second side region 160 extending along second edge 96 between second corner 130 and fourth corner 134. A fourth portion 164 of the plurality of energy absorption members 116 is disposed in each of the first side region 158 and the second side region 160. The fourth portion 164 of the plurality of energy absorption members 116 is formed by fourth openings or voids 166 in tunable spring member 66 that create a fourth spring rate in each of the first deflection area 102 and the second deflection area 108 at the first side region 158 and the second side region 160. The fourth third spring rate may be less than the second spring rate yet greater than the first spring rate.

By selecting opening sizes to create desired spring rates to accommodate more or less force, tunable spring member 66 may be tailored to force a more uniform expansion of, for example, first surface section 80 and/or second surface 84 as shown in FIG. 8. That is portions of tunable spring member 66 are designed to absorb more or less of the battery cell expansion such that areas with greater expansion forces are restrained and areas with lesser expansion forces are less restrained such that the overall expansion of the battery cell is uniform. Further while the energy absorption members are shown as circular openings, the shape of the openings may vary as may the spacing between adjacent openings. Therefore, the tunable spring member represents a cost effective solution that fills spaces between adjacent battery cans at a beginning of life (BOL) and may absorb compressive forces over the operational life of the battery assembly as battery cells expand.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly comprising:
a first battery cell including a first surface and a first surface section, the first surface section being opposite of the first surface;
a second battery cell including a second surface and a second surface section, the second surface section being opposite of the second surface; and
a tunable spring member provided between the first battery cell and the second battery cell, the tunable spring member including a first spring surface facing the first surface section and a second spring surface facing the second surface, the tunable spring member including a plurality of energy absorption zones disposed across the first spring surface and the second spring surface, a first portion of the plurality of energy absorption zones establishing a first spring rate, and a second portion of the plurality of energy absorption zones establishing a second spring rate that is distinct from the first spring rate.

2. The battery assembly according to claim 1, wherein the tunable spring member includes a first side, a second side arranged opposite the first side, a first edge extending between and connecting the first side and the second side, and a second edge, opposite the first edge, extending between and connecting the first side and the second side, the first side, the second side, the first edge, and the second edge defining a deflection area.

3. The battery assembly according to claim 2, wherein the first edge and the first side form a first corner, the first edge and the second side form a second corner, the second edge and the first side form a third corner, and the second edge and the second side form a fourth corner, the first portion of the plurality of energy absorption zones being disposed at one of the first corner, the second corner, the third corner, and the fourth corner.

4. The battery assembly according to claim 3, wherein the first corner, the second corner, the third corner, and the fourth corner includes one of the first portion of the plurality of energy absorption zones.

5. The battery assembly according to claim 3, wherein the deflection area includes a central deflection zone defined between the first edge, the second edge, the first side, and the second side, wherein the central deflection zone includes a plurality of the second portion of the plurality of energy absorption zones.

6. The battery assembly according to claim 5, wherein the deflection area includes a first edge region defined between the first corner and the second corner and a second edge region defined between the third corner and the fourth corner, wherein the first edge region and the second edge region includes a third portion of the plurality of energy absorption zones establishing a third spring rate.

7. The battery assembly according to claim 6, wherein the deflection area includes a first side region defined between the first corner and the third corner and a second side region defined between the second corner and the fourth corner, wherein the first side region and the second side region includes a fourth portion of the plurality of energy absorption zones establishing a fourth spring rate.

8. The battery assembly according to claim 7, wherein the third spring rate is distinct from the fourth spring rate.

9. The battery assembly according to claim 8, wherein the third spring rate and the fourth spring rate are distinct from the first spring rate and the second spring rate.

10. The battery assembly according to claim 2, wherein each of the first portion of the plurality of energy absorption zones is defined by an opening having a first dimension formed in the deflection area and each of the second portion of the plurality of energy absorption zones is defined by a second opening having a second dimension formed in the deflection area, the first dimension being distinct from the second dimension.

11. A vehicle comprising:
a body including a passenger compartment;
a electric drive unit supported in the body; and
a battery assembly operatively connected to the electric drive unit, the battery assembly comprising:
a first battery cell including a first surface and a first surface section, the first surface section being opposite of the first surface;
a second battery cell including a second surface and a second surface section, the second surface section being opposite of the second surface; and
a tunable spring member provided between the first battery cell and the second battery cell, the tunable spring member including a first spring surface facing the first surface section and a second spring surface facing the second surface, the tunable spring member including a plurality of energy absorption zones disposed across the first spring surface and the second spring surface, a first portion of the plurality of energy absorption zones establishing a first spring rate, and a second portion of the plurality of energy absorption zones establishing a second spring rate that is distinct from the first spring rate.

12. The vehicle according to claim 11, wherein the tunable spring member includes a first side, a second side arranged opposite the first side, a first edge extending between and connecting the first side and the second side, and a second edge, opposite the first edge, extending between and connecting the first side and the second side, the first side, the second side, the first edge, and the second edge defining a deflection area.

13. The vehicle according to claim 12, wherein the first edge and the first side form a first corner, the first edge and the second side form a second corner, the second edge and the first side form a third corner, and the second edge and the second side form a fourth corner, the first portion of the plurality of energy absorption zones being disposed at one of the first corner, the second corner, the third corner, and the fourth corner.

14. The vehicle according to claim 13, wherein the first corner, the second corner, the third corner, and the fourth corner includes one of the first portion of the plurality of energy absorption zones.

15. The vehicle according to claim 13, wherein the deflection area includes a central deflection zone defined between the first edge, the second edge, the first side, and the second side, wherein the central deflection zone includes a plurality of the second portion of the plurality of energy absorption zones.

16. The vehicle according to claim 15, wherein the deflection area includes a first edge region defined between the first corner and the second corner and a second edge region defined between the third corner and the fourth corner, wherein the first edge region and the second edge region includes a third portion of the plurality of energy absorption zones establishing a third spring rate.

17. The vehicle according to claim 16, wherein the deflection area includes a first side region defined between the first corner and the third corner and a second side region defined between the second corner and the fourth corner, wherein the first side region and the second side region includes a fourth portion of the plurality of energy absorption zones establishing a fourth spring rate.

18. The vehicle according to claim 17, wherein the third spring rate is distinct from the fourth spring rate.

19. The vehicle according to claim 18, wherein the third spring rate and the fourth spring rate are distinct from the first spring rate and the second spring rate.

20. The vehicle according to claim 12, wherein each of the first portion of the plurality of energy absorption zones is defined by an opening having a first dimension formed in the deflection area and each of the second portion of the plurality of energy absorption zones is defined by a second opening having a second dimension formed in the deflection area, the first dimension being distinct from the second dimension.
